(19) United States
(12) Patent Application Publication
(10) Pub. No.: US 2010/0171324 A1
(43) Pub. Date: Jul. 8, 2010

(54) DOOR HANDLE FOR THE ACTUATION OF A DOOR OF AN AUTOMOBILE FROM THE INSIDE

(75) Inventor: Uwe Stapf, Roettingen (DE)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: ITW AUTOMOTIVE PRODUCTS GMBH & CO. KG, Iserlohn (DE)

(21) Appl. No.: 12/376,869

(22) PCT Filed: Oct. 23, 2007
(86) PCT No.: PCT/IB07/03180

§ 371 Date: Feb. 9, 2009

(30) Foreign Application Priority Data
Nov. 11, 2006 (DE) 10 2006 052 250.3

(51) Int. Cl. E05B 7/00; E05B 65/20

(52) U.S. Cl. 292/336.3

(57) ABSTRACT

An automobile inside door-actuation device comprising a housing which can be assembled to the door's frame and a drive lever pivotably supported inside the housing on pivot pins, characterized in that the drive lever, the pivot pins and the housing are molded from plastic(s) by two-component injection molding into one unit, the properties of the selected plastics being such that the mutually displaceable parts do not bond to each other during injection molding.

The present invention relates to an automobile inside door-actuation device.

It is well known that automobile doors may be actuated both from the inside and the outside. The actuation elements act on the door lock by means of rods or tensile elements. As regards inside actuation, in general a drive lever pivotably supported in a housing is used and is affixed, for instance by screw means, into the door frame. It is known to make both said drive lever and the housing of plastic. These two components must be joined to each other when the inside door actuating device is installed.

The objective of the present invention is to create a device implementing automobile inside door-actuation such that said device reduces the complexity of its installation.

This problem is solved by the features of claim 1.

In the present invention, both the drive lever together with its pivot pins and the housing are made as one unit using a two-component plastic injection molding procedure. The selected plastics are such that the mutually displaceable parts shall not join one another during the injection molding procedure.

In a particular implementing mode of the present invention, pivot pins are integrated into the drive lever and enter bearing recesses in said housing.

The present invention is based on the insight there are plastics suitable for injection molding that remain free from a chemical or adhesive bond during two-component injection molding but remain separate from one another. Illustratively a pair of bearing pins may be constituted at the drive lever and may enter commensurately shaped housing recesses without thereby the pivot pins bonding during injection molding with the bearing recess wall.

In the present invention, therefore, the inside door-actuation is already implemented by one injection molded unit. Said unit then need only be conventionally affixed by means of the housing to the door frame. The savings of such an assembly are significantly reduced.

One illustrative embodiment of the present invention is discussed below in relation to the appended drawings.

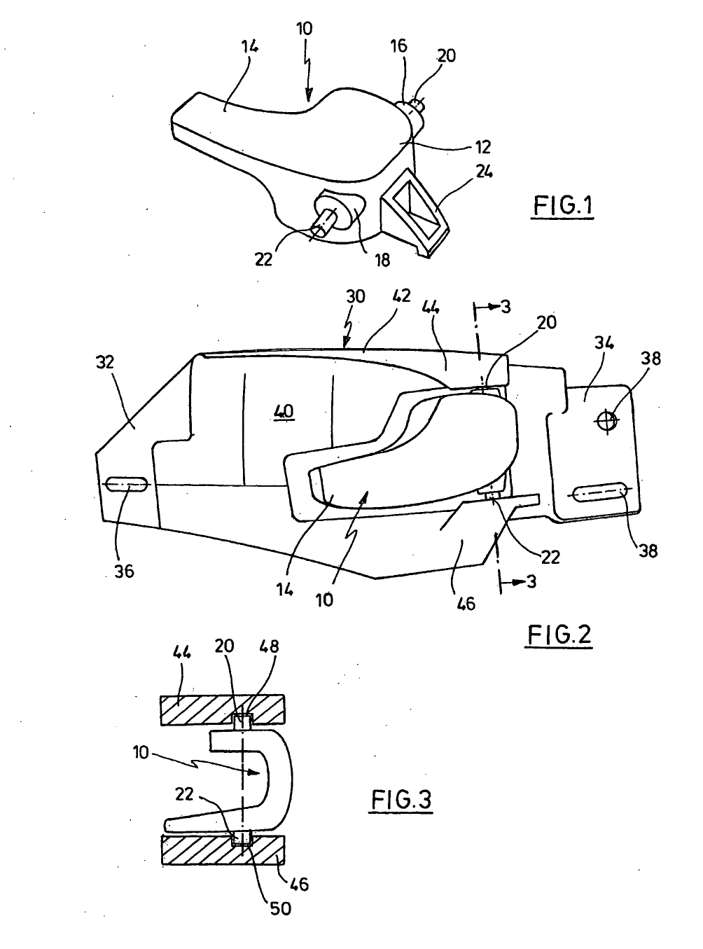

FIG. 1 is a perspective view of a drive lever used in an automobile inside door-actuation device,

FIG. 2 is a sideview of an inside door-actuation device comprising a drive lever shown in FIG. 1, and

FIG. 3 is a section along line 2-3 of FIG. 2.

FIG. 1 shows a drive lever 10 comprising rest segment 12 and a comparatively slender actuation portion 14. On its other side, not seen, the drive lever 10 is hollow to save material.

Cylindrical protrusions 16, 18 are constituted coaxially on mutually opposite sides at the rest segment 12, each side being fitted with a cylindrical, coaxial, respective pivot pin 20, 22 integrated into these protrusions. A ramp-like fitting 24, of which the axis runs perpendicularly to the axis of the pivot pins 20, 22, joins the rest segment 12 and acts as a limit stop on the pivoting excursion.

FIG. 2 shows a plastic housing 30 fitted at its opposite ends with flanges 32 and 34 comprising respectively slots 36 and 38 for screw affixation to the frame of an omitted door of an omitted automobile. In-between the flanges 32, 34, the housing 30 is fitted with a comparatively flat rear wall 40 which comprises at its upper end an upper wall portion 42 bent out of the plane of the drawing and constituting an upper rest segment 44. Another rest segment 46 is constituted opposite said segment 44 and must be construed projecting from the rear wall 40, that is from the plane of the drawing. As shown in FIG. 3, cylindrical recesses 48, 50 are present one each respectively in the rest segments 44, 46 and receive the pivoting bearing pins 20, 22. Consequently the drive lever 10 is pivotably supported about a vertical axis within the housing 30. The drive lever is connected to an omitted link system in turn operationally connected to a door lock. Moreover the drive lever 10 is biased by an omitted spring toward the rest position shown in FIG. 2, the fitting 24 predetermining the rest position.

The peculiarity of the inside door-actuation device of FIG. 2 is its being manufactured as one unit two-component injection molding. In this procedure, the drive lever 10 together with the pivot pins 20, 22 is manufactured using a first plastic. Then the housing 30 is injection molded using a second plastic, or, upon appropriate selection, again using the first one. The plastics are such that the pins 20, 22 determine the shape of the bearing recesses 48, 50 while averting bonding between the pins 20, 22 and the bearing recesses 48, 50. Indeed, following the injection molding procedure, the drive lever may be pivoted freely pivoted in the above described manner about the vertical axis to effect door opening.

1. An automobile inside door-actuation device comprising a housing which can be assembled to the door's frame and a drive lever pivotably supported inside the housing on pivot pins, characterized in that the drive lever, the pivot pins and the housing are molded from plastic(s) by two-component injection molding into one unit, the properties of the selected plastics being such that the mutually displaceable parts do not bond to each other during injection molding.

2. Device as claimed in claim 1, characterized in that pivot pins which are situated on one axis and which are integrated into the drive lever, engage bearing recesses of the housing.
